(19) United States
(12) Patent Application Publication
(10) Pub. No.: US 2007/0106498 A1
(43) Pub. Date: May 10, 2007

(54) Mobile communication terminal and method therefor

(75) Inventor: John Hard, Malmo (SE)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/270,819

(22) Filed: Nov. 10, 2005

(51) Int. Cl. G06F 17/21

(52) U.S. Cl. 704/10

(57) ABSTRACT

A method is provided for text input in which a command is received to activate a dictionary input mode. Thereafter an input sequence is received and interpreted thereby generating a word. As the word is accepted it is stored in a dictionary. Corresponding apparatus and a computer program are also provided.

### FIELD OF THE INVENTION

The present invention generally relates to text input and more particularly to predictive text input and predictive text input in mobile communication terminals.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost only for voice communication with other mobile terminals or stationary telephones. More recently, the use of modem terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

Text input plays a major role in many of these applications, and especially for messaging and as most mobile terminals only have limited keypads, special techniques and tools have been developed to help the user input text faster. One set of such tools is the popular predictive editors, such as TEGIC'S T9®. Using the T9 predictive input engine speeds up text inputs, as the text input engine predicts what word is being input by comparing the input sequence to a dictionary stored in the terminal's memory and then presenting candidates that the user can choose from. The user scrolls through these candidates one by one with a candidate scroll key (in NOKIA phones this is the ‘*’-key) and selects the candidate currently displayed by taking further action such as unmarking it or inputting a space character. As long as the word, that the user wants to input, is to be found this works very well, but if the user tries to input a word that is not in the used dictionary, the editor application will prompt him to spell the word explicitly and then save it afterwards so that it is in the dictionary the next time the user writes it. A descriptive example of this follows describing what happens if the user tries to input a word not in the dictionary, say “USPTO”, using a NOKIA 5140™.

The user starts by typing in the sequence [8 7 7 8 6], and the editor application searches the dictionary simultaneously with the input and finally produces the candidate “UPSTO”. This is not right so the user scrolls through the candidate list by pressing the corresponding candidate scroll key, in this case the ‘*’-key. As there are no more options the user is given the option of manually inputting the correct word on the left softkey. Choosing this option opens up an editor window in which the user can type in the correct word using multitap (or non-predictive) input and then save it to the dictionary. As the spelling editor is closed, the correct word will be displayed in its place in the text.

It is quite frustrating to a user to first have to input the whole sequence and scroll through a candidate list before being given the option of manually inputting the word and saving it. This is especially so if the user knows that the word is not in the dictionary and that it is a word he will be wanting to input quite often. In this case the user has to either type in the sequence and scroll through the candidate list until given the option to input and save it, or to change input modes and input the word or string manually and then take steps to save it, which in the NOKIA 5140™would be to go back and mark the word, open the options menu, select Edit which opens the spelling editor and then from the spelling editor choose to save the word and return to continue typing. Both alternatives require extensive knowledge about the system and that multiple steps are taken in a specific order.

Consequently, there is a need to provide a convenient and efficient way to input words known not to be in the currently used dictionary.

### SUMMARY

According to an aspect of the invention, a method for text input is provided comprising the steps of:

receiving a command to activate a dictionary input mode;

receiving an input sequence;

interpreting said input sequence and generating a word accordingly; and

upon receiving an accept storing said word in a dictionary.

This has the advantage of giving the user a simple and efficient way of adding words to a dictionary and only having to input them once. If the command to enter the dictionary input mode is a simple key press, the method becomes even faster and easier to learn. If the key to be used is the same key as is used for candidate scrolling the method becomes very easy to learn as the user is already accustomed to using that key in combination with predictive input and candidate selection.

In one instance of the invention, the word to be input and saved is typed in directly in the editor window which gives a clear and easy to understand user interface as well as placing a low demand on the hardware and processing. In another instance the word to be input and saved is input in a specific editor window that is opened and then closed after the word has been input. This window clearly signals to the user that the input being made is of a special kind and thus helps reducing any confusion.

Another aspect of the invention includes a method for text input wherein said steps are performed in a mobile communications terminal.

A further aspect of the invention includes text input means for saving an input word in a dictionary upon input comprising input mode changing means for activating a dictionary input mode, input means for receiving an input word, and storing means for storing the input word in the dictionary upon reception of an accept through the input means.

An additional aspect of the invention includes a computer program comprising software instructions that, when executed in a mobile communication terminal, performs a method according to another aspect of the invention.

Other features and advantages of the present invention will appear from the following detailed disclosure, from the attached claims, and from the drawings.

Generally, all terms used in the claims are to be interpreted according to their ordinary meaning in the technical field, unless explicitly defined otherwise herein. All references to “a/an/the [element device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Example embodiments of the present invention will now be described in more detail, reference is being made to the enclosed drawings, in which:

FIG. 1 is a schematic illustration of a cellular telecommunication system, as an example of an environment in which aspects of the present invention may be applied.

FIG. 2 is a schematic front view illustrating a mobile terminal according to an embodiment of the present invention.

FIG. 3 is a schematic block diagram representing an internal component, software and protocol structure of the mobile terminal shown in FIG. 2.

FIG. 4 is a series of screen shots for an embodiment according to the invention.

FIG. 5 is a flow chart describing an embodiment of the invention.

FIG. 6 shows screen shots for an embodiment of the invention.

### DETAILED DESCRIPTION OF THE DRAWINGS

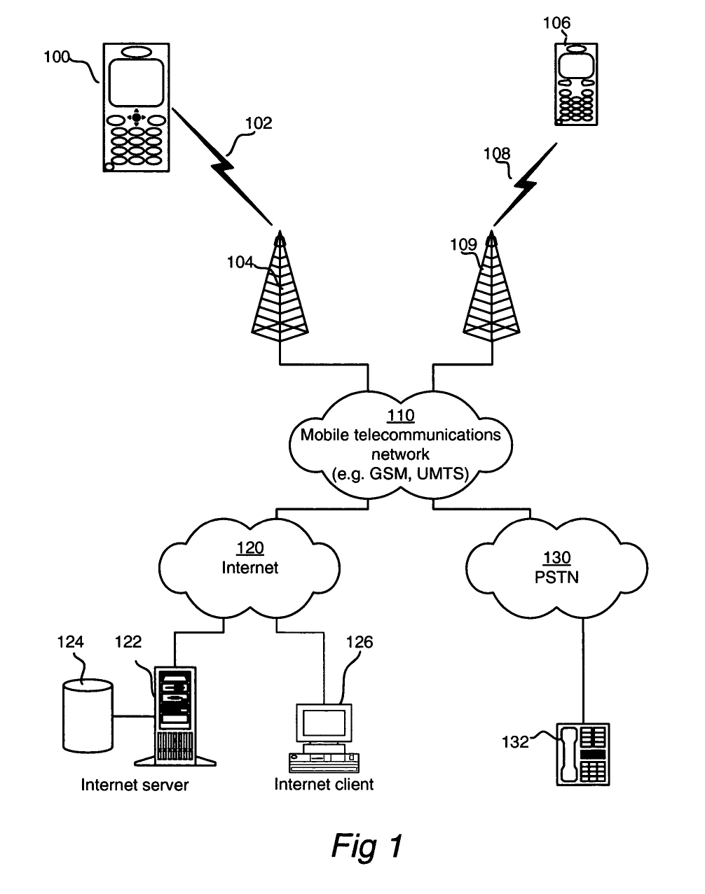

FIG. 1 illustrates an example of a cellular telecommunications system in which the invention may be applied. In the telecommunication system of FIG. 1, various tele-communications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according an embodiment of the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile tele-communications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile tele-communications network 110 in a familiar manner. Various telephone terminals, including the stationary telephone 132, are connected to the PSTN 130.

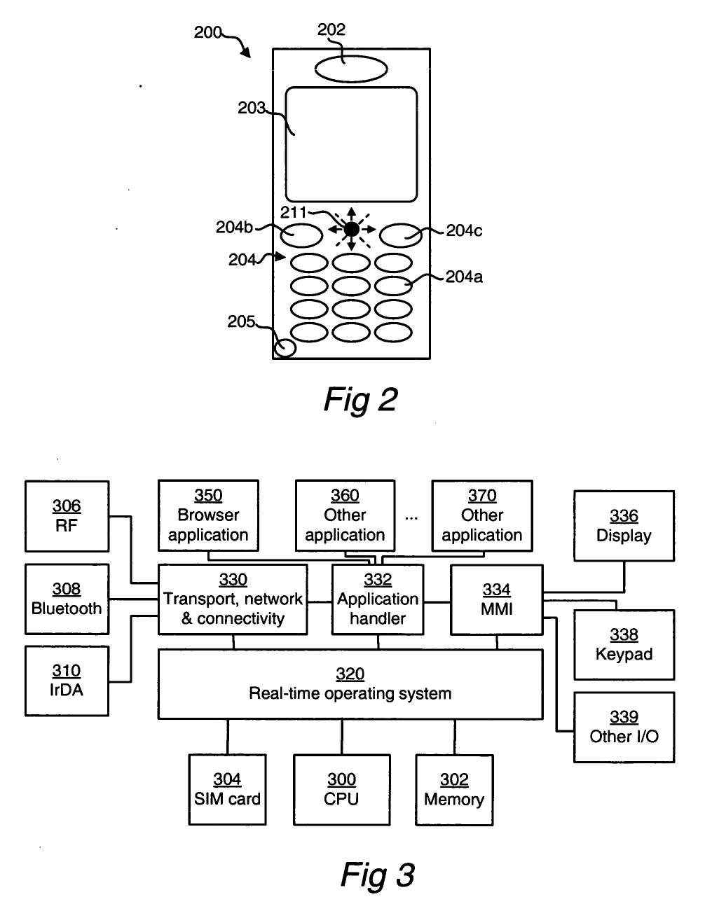

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a browser application 350, as well as various other applications 360 and 370, such as applications for voice calling, video calling, sending and receiving SMS, MMS or email, an instant messaging application, a phone book application, a calendar application, a control panel application, a camera application, a media player, one or more video games, a notepad application, etc. An application cooperating with some of the applications listed above could be an editor application that could either be a standalone application or a sub part of the application using it.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

In one embodiment of the present invention a user can input words in an editor application using a predictive input engine having a dictionary holding a multitude of words that are stored in the memory. If the user wants to input a text that contains a word that the user knows is not in the dictionary being used, like an unusual name, a composite word, an acronym, a field specific word or just an unusual word, the user only has to inform the predictive editor that he is about to type in an unknown word that should be saved in the dictionary by changing the input mode.

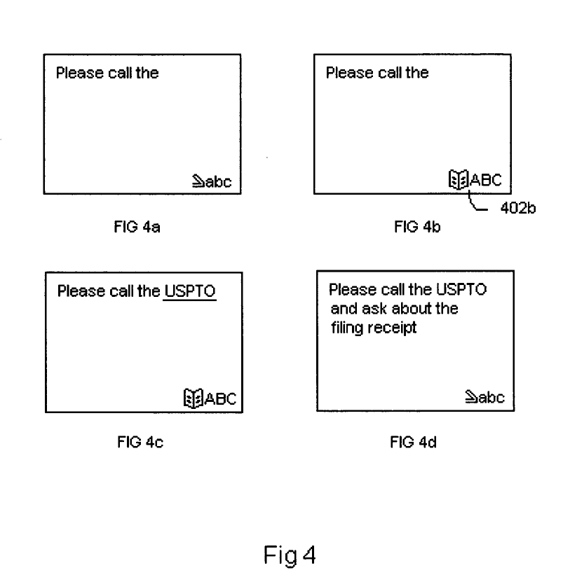

See FIG. 4 for an example. The user wants to type the string “Call the USPTO and ask about the filing receipt”. Typing in the first three words is done as in the prior art using the predictive engine, ie pressing the keys associated with each letter in the word and choosing between the presented candidates using a candidate selection key such as the ‘*’-key, see FIG. 4a. It is now time to input the unknown word “USPTO”, and the user simply switches input mode from predictive mode to a dictionary input mode by pressing a mode select key, such as the hash key (‘#’-key), thereby generating a command to activate the dictionary input mode, which command is received by the editor application. The new input mode is shown to the user by changing the icons in the display, see 402b in FIG. 4b. The user can now input the unknown word using multitap input, whereby the user's key presses are sent as an input sequence which is simultaneously interpreted according to multitap input rules thereby generating a word, see FIG. 4c. To indicate to the user that the word is being processed by the predictive engine the word could be marked in some way, like being underlined. As the user accepts the word, by either demarking it by scrolling away from it or by inputting a space character, as is a commonly known way to accept a word using a predictive engine, the input word is stored in the dictionary and the input mode is switched back to normal predictive input mode, see FIG. 4d. The user can now continue typing in the rest of the string using the predictive editor.

As is apparent the embodiment described above is very quick to use, easy to learn and requires a minimum of processing power and input means.

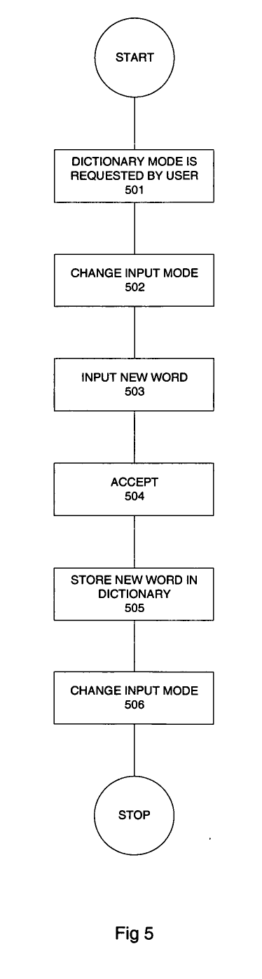

The basic steps taken in the example above are shown in FIG. 5. First the user informs the editor that the next word is unknown and should be saved in the dictionary, step 501. In response to this the controller of the mobile terminal switches the input mode from predictive to multitap input, step 502. The unknown word is then input, step 503. As the user is finished typing in the word, it is accepted in step 505 and stored in the dictionary in step 506, and the input mode is changed back to predictive input in step 507.

In an embodiment of the invention the dictionary input mode is chosen by pressing a candidate selection key, such as the ‘*’-key, also called a dictionary input mode select key in the context of the present invention. Normally, this key would be used to select between candidates as a word is being input using a predictive engine. As nothing is marked at the start of an input, this functionality of the ‘*’-key would not apply, and the key could then instead be used to activate the dictionary input mode. This would be easy to learn for a user, as the key is commonly associated with the predictive input, and fast, as only one key press would be necessary to change the input mode.

Another possibility would be to add the dictionary input mode to the set of available input modes predictive input; multitap input and number input.

In another embodiment the user can accept the word by activating a soft key.

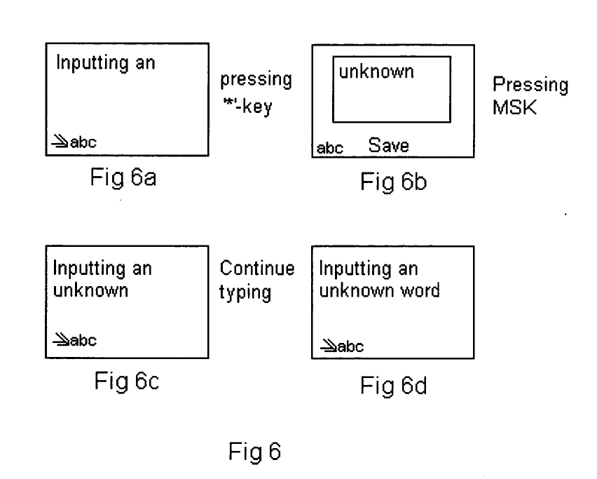

In another embodiment of the invention, see FIG. 6, as a user tries to input an unknown word, see FIG. 6a, a special input window could be opened as the dictionary input mode is chosen. The unknown word would be input in this window, see FIG. 6b, and as the word is accepted the window disappeared and the recently input word is displayed as part of the text, see FIG. 6c. The user could then continue typing, see FIG. 6d. This embodiment has the benefit of resembling the now used editor according to the prior art for inputting words that were not recognized. In these prior art text editors a specific frame is opened where the user can type in the correct form of the unknown word and save it. The flame is then closed and the new word is input in the text accordingly.

Although the descriptions above have been focusing on input using an ITU-T keypad having 12 keys, the invention could also be implemented using a rotator input such as the one used in the NOKIA 7280™. Instead of having a mode switch key, the user would select a wanted mode switch icon from the input banner while the string is marked to change the mode of the string.

It should be noted that the present invention could also be used with pen input whereby the keypresses are exchanged for penstrokes and virtual keypresses.

It should also be noted that the dictionary input mode select key could be any key, both physical and virtual, and could also be a roller or a rotator key.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for text input comprising the steps of:
receiving a command to activate a dictionary input mode;
receiving an input sequence;
interpreting said input sequence and generating a word accordingly; and
upon receiving an accept, storing said word in a dictionary.

2. A method for text input according to claim 1, wherein the step of receiving a command to activate a dictionary input mode further includes changing an input mode from an original input mode to a multitap input mode.

3. A method for text input according to claim 2, wherein said original input mode is a predictive input mode.

4. A method for text input according to claim 2, further comprising a step of resetting said input mode to said original input mode.

5. A method for text input according to claim 1, wherein the step of receiving a command to activate a dictionary input mode further includes generating said command upon activation of a dictionary input mode select key.

6. A method for text input according to claim 5, wherein said dictionary input mode select key is the candidate scroll key.

7. A method for text input according to claim 1, wherein the step of receiving an input sequence includes opening an editor window on a display, the step of interpreting said input sequence and generating a word accordingly includes displaying said word as it is generated in said editor window and the step of upon receiving an accept storing said word in a dictionary includes closing said editor window.

8. A method for text input according to claim 1, wherein said input sequence received in the step of receiving an input sequence represents a sequence of actuations of an input device by a user.

9. A method for text input according to claim 8, wherein said sequence of actuations involves actuations of different keys on a keypad.

10. A method for text input according to claim 1, wherein said word is appended to a current text input as generated prior to the step of receiving a command to activate a dictionary input mode.

11. A method for text input according to claim 1, wherein said steps are performed in a mobile communications terminal.

12. A computing device for text input comprising:
a processor;
memory containing computer readable instructions instructing said processor to perform steps comprising:
receiving a command to activate a dictionary input mode;
receiving an input sequence;
interpreting said input sequence and generating a word accordingly; and
upon receiving an accept, storing said word in a dictionary.

13. A device according to claim 12, wherein said computing device is a mobile communications terminal.

14. A computer readable medium having computer readable instructions stored thereon that, when executed in a mobile communication terminal, performs steps comprising:
receiving a command to activate a dictionary input mode;
receiving an input sequence;
interpreting said input sequence and generating a word accordingly; and
upon receiving an accept, storing said word in a dictionary.

15. A computing device comprising text input means for saving an input word in a dictionary upon input, the text input means comprising:
input mode changing means for activating a dictionary input mode;
input means for receiving an input word; and
storing means for storing said input word in said dictionary upon reception of an accept through said input means.
